(19) United States
(12) Patent Application Publication
(10) Pub. No.: US 2005/0188910 A1
(43) Pub. Date: Sep. 1, 2005

(54) Single-use biotherm for reducing foodborne illnesses

(76) Inventor: Polly Dee McCorkle, Cicero, IN (US)

Correspondence Address: JEFFREY J. VAITEKUNAS, 17650 HYDE PARK AVE., LAKEVILLE, MN, 55044, US

(21) Appl. No.: 11/065,765

(22) Filed: Feb. 25, 2005

Related U.S. Application Data
(60) Provisional application No. 60/549,043, filed on Mar. 1, 2004.

(51) Int. Cl. G01K 1/02

(52) U.S. Cl. 116/216

(57) ABSTRACT

A single use disposable thermometer/biotherm including devices and methods for preventing food cross-contamination and reducing foodborne illnesses. A single-use biotherm includes a biotherm body having a proximal end and a distal end, with a frangible portion fracturably attached to the biotherm body. A temperature sensitive arrangement is located in or on the biotherm body. A first temperature indicating arrangement is located in or on the frangible portion and coupled to the temperature sensitive arrangement. Fracturing the frangible portion from the biotherm body captures the temperature indicated by the temperature indicating arrangement. A method of reducing foodborne disease involves providing a single use biotherm; inserting the biotherm into a food product; and receiving an indication of the temperature of the food from the biotherm. The biotherm is then disposed after receiving the temperature indication from the food product.

### RELATED PATENT DOCUMENTS

This application claims the benefit of Provisional Patent Application Ser. No. 60/549,043, filed on Mar. 1, 2004, to which priority is claimed pursuant to 35 U.S.C. §119(e) and which is hereby incorporated herein by reference.

### FIELD OF THE INVENTION

The present invention relates, in general, to single use disposable thermometer/biotherms and, more particularly, to devices and methods for preventing food cross-contamination and reducing food borne illnesses.

### BACKGROUND OF THE INVENTION

The Council for Agricultural Science and Technology estimates 6.5 to 33 million people become ill from microorganisms in food resulting in as many as 9000 needless deaths every year. The cost annually from foodborne illness is in the billions of dollars.

Foodborne illness occurs most frequently in the retail segment of the food industry where food is prepared and served to the public, i.e. restaurants, markets, schools, camps, churches, and institutions. Mishandling of food most often occurs in these settings/situations/environments.

Large volume preparation of food and service of large quantities of food present particular challenges to reduce the chance of spreading foodborne disease. A single cross-contamination between two service elements can begin a cascade of events resulting in the illness or death of a large number of people.

Reducing the chance of food contamination is particularly important for sensitive or critical applications such as, for example, military services, school lunches, child care, elder care, pregnancy, and food preparation aboard cruise ships. Even low-burden food borne illnesses can adversely affect groups of people with weakened abilities such as those in nursing homes, extended care facilities, hospitals, or other group settings where weakened individuals are provided with food.

Problems with food borne contamination have prompted the actions of government agencies to prepare guidelines and/or rules for sanitation requirements such as, for example, the Indiana State Department of Health Title 410 IAC-7-22 Certification of Food Handler Requirements. The Indiana legislature adopted IC 16-42-5.2, which states at least one person per food establishment must be certified and is a mandatory requirement. Requirements such as these often include the use of a biotherm to measure temperatures of foods during preparation, while preparing for presentation, during service, and when re-heating food product. Many other states are in the process of adopting, or have already adopted, similar requirements.

Although the sanitation requirements are helpful, cross-contamination and non-adherence to the requirements occur. It would be advantageous to provide devices and methods to reduce cross-contamination and food borne disease.

### SUMMARY OF THE INVENTION

Disclosed are a single use disposable thermometer/biotherm including devices and methods for preventing food cross-contamination and reducing food borne illnesses. A single use disposable thermometer/biotherm in accordance with the present invention reduces the chance of cross-contamination. It also provides for more than one person to keep an eye on the indicator while the biotherm is in use. Being relatively inexpensive, it will provide the general public with a hands-on device that is disposable, and increases their awareness of foodborne illness and the importance time and temperature plays on the safe consumption of food.

In a first embodiment, a single-use biotherm includes a biotherm body having a proximal end and a distal end, with a frangible portion fracturably attached to the biotherm body. A temperature sensitive arrangement is located in or on the biotherm body. A first temperature indicating arrangement is located in or on the frangible portion and coupled to the temperature sensitive arrangement. Fracturing the frangible portion from the biotherm body captures the temperature indicated by the temperature indicating arrangement.

In another embodiment the biotherm further includes a second temperature indicating arrangement located in or on the frangible portion, and coupled to the temperature sensitive arrangement. The first temperature sensitive arrangement is configured to indicate a first range of temperatures and the second temperature arrangement is configured to indicate a second range of temperatures different than the first range of temperatures.

In another embodiment of the present invention, a timer is located in or on the biotherm body and configured to indicate when a time limit is exceeded after a trigger event, the trigger event triggered by the temperature indicating arrangement. In particular embodiments of the present invention the biotherm is configured to be sensitive within the range of about 120 degrees Fahrenheit and about 180 degrees Fahrenheit. In another particular embodiment of the present invention, the biotherm is configured to be sensitive within the range of about 140 degrees Fahrenheit and about 170 degrees Fahrenheit. In yet another particular arrangement, the biotherm has a first temperature indicating arrangement configured to indicate a temperature above about 140 degrees Fahrenheit and a second temperature indicating arrangement configured to indicate a temperature of about 161 degrees Fahrenheit.

In another embodiment of the present invention, a single-use biotherm includes a biotherm body having a proximal end and a distal end, with a temperature sensitive arrangement located in or on the biotherm body. A first temperature indicating arrangement is located in or on the biotherm body, the temperature indicating arrangement being coupled to the temperature sensitive arrangement. The first temperature indicating arrangement is configured to indicate when the temperature sensitive arrangement senses a temperature exceeds a first set-point, and is further configured to indicate when the temperature sensitive arrangement senses a temperature below a second set-point after the temperature has exceeded the first set-point. Dual set-point biotherms according to the present invention may also include timer, clips, and other combinations of embodiments of the present invention described above.

According to another embodiment of the present invention, a method of reducing food borne disease is disclosed, the method involving providing at least one single use biotherm, where the biotherm includes a biotherm body having a proximal end and a distal end. A temperature sensitive arrangement is located in or on the biotherm body. A first temperature indicating arrangement is located in or on the biotherm body, the temperature indicating arrangement coupled to the temperature sensitive arrangement. The temperature sensitive arrangement may have reversible or non-reversible temperature sensitivity. The method further involves inserting one of the single use biotherms into a food product, and receiving an indication of the temperature of the food from the biotherm. The biotherm is then disposed after receiving the temperature indication from the food product.

In another embodiment of the present invention, the method may further involve providing a plurality of single use biotherms, and inserting each of the plurality of biotherms into its own single food product, thereby eliminating cross-contamination between the food products. The biotherm may include a clip configured to retain the biotherm in a pan of food and methods may include clipping the biotherm to a food pan.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

The features of the invention may be set forth with particularity in the appended claims. The invention itself, however, both as to organization and methods of operation, together with further objects and advantages thereof, may best be understood by reference to the following description, taken in conjunction with the accompanying drawings in which:

FIG. 1 is a plan view of a biotherm in accordance with the present invention;

FIG. 2 is a plan view of a display of a biotherm in accordance with the present invention;

FIG. 3 is a side view of a biotherm in accordance with the present invention; and

FIG. 4 is a side sectional view of a biotherm illustrated in a food pan in accordance with the present invention.

### DETAILED DESCRIPTION OF THE INVENTION

In the following description of the illustrated embodiments, references are made to the accompanying drawings, which form a part hereof, and in which is shown by way of illustration various embodiments in which the invention may be practiced. It is to be understood that other embodiments may be utilized, and structural and functional changes may be made without departing from the scope of the present invention.

Devices and methods for reducing food borne illnesses and contamination employing biotherms implemented in accordance with the present invention can incorporate one or more of the features, structures, methods, or combinations thereof described herein below. For example, a biotherm can be implemented to include one or more of the advantageous features and/or processes described below. It is intended that such a device or method need not include all of the features and functions described herein, but can be implemented to include one or more selected features and functions that provide for unique structures and/or functionality.

The present invention relates, in general, to single use disposable thermometer/biotherms and, more particularly, to devices and methods for preventing food cross-contamination and reducing food borne illnesses. Some devices and methods of manufacturing disposable thermometer/biotherms useful in accordance with the present invention are described in U.S. Pat. Nos. 3,946,612; 4,189,942; 4,232,552; 4,345,470; 4,397,570; 4,339,207; and 4,362,645; 5,816,707; each hereby incorporated herein by reference in their respective entireties.

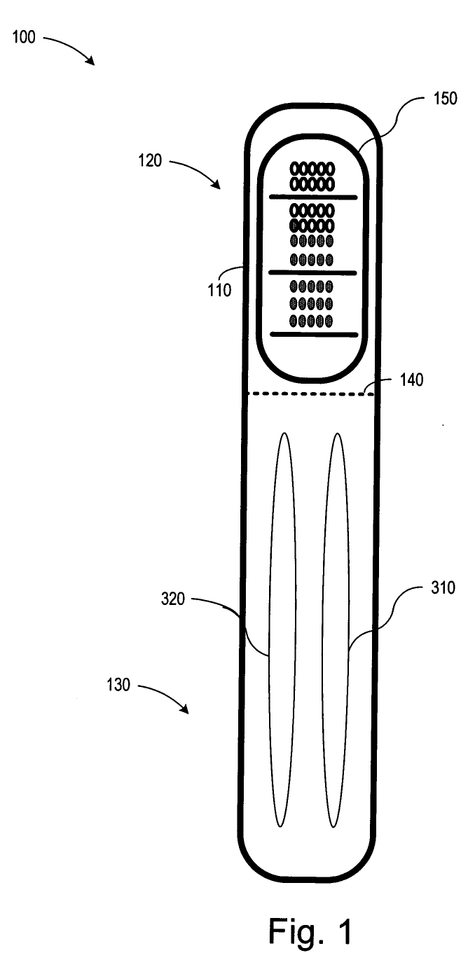

Referring now to FIG. 1, a biotherm 100 is illustrated in accordance with the present invention. The biotherm 100 includes a body 110 having a proximal portion 120 and a distal portion 130. A display 150 is provided on the proximal portion 120 to provide a visual indication to a user. The visual indication may provide temperature information to a user, as well as other information such as, for example, timing information, as will be described below in more detail.

The body 110 is illustrated having optional ridges 310 and 320, useful for providing stiffness to the body 110 as well as for locating the body 110 away from heat sources not intended to be measured, as will be described below. The biotherm 100 may be manufactured from plastic, such as, for example, an injection molded polymer, or other suitable material as is known in the art.

A fracture line 140 may be incorporated into the body 110 to provide a frangible portion, such as, for example, the proximal portion 120. Fracturing the body 110 along the fracture line 140 separates the display 150 from the distal portion 130, providing a convenient record for retaining the temperature history and/or timing at temperature of the biotherm 100. For example, it may be desirable to provide a single use biotherm 100 for each food product provided for consumption. After use the display 150 may be retained for record retention on proximal portion 120, without need to clean or preserve the distal portion 130.

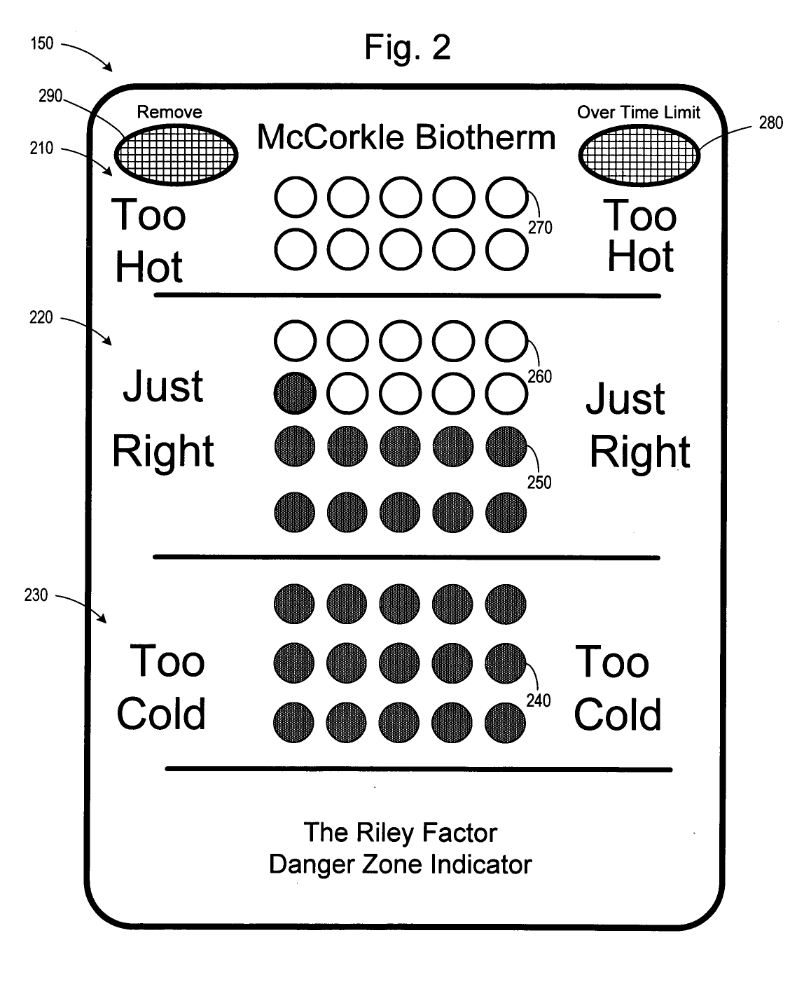

Referring now to FIG. 2, a magnified view of an embodiment of the display 150 is illustrated. The display 150 may include a too hot indication range 210, a too cold indication range 230, and a just right indication range 220. The indication ranges 210, 220, and 230 may include a plurality of temperature indicating elements, such as, for example, too cold temperature indicating dot 240, just right temperature indicating dot 250, just right temperature indicating dot 260, and too hot temperature indicating dot 270.

The temperature indicating dots 240, 250, 260 and 270 may be, for example, visual displays for observing a change of state of compositions of matter that are reversibly responsive to temperature, such as, for example, compositions known in the art and described in U.S. Pat. No. 5,816,707, previously incorporated by reference. It may also be desirable to provide non-reversible temperature indicating dots 240, 250, 260, and 270 for maintaining permanent records of temperatures and times using frangible portions of biotherms, as described above. An example of compositions and methods of manufacture for non-reversible temperature indicating dots 240, 250, 260, and 270 are also known in the art, such as, for example, those described in U.S. Pat. No. 3,946,612, previously incorporated by reference.

Referring to FIGS. 1 and 2, in another embodiment of the present invention, the display 150 may include a first time indicator 280, and a second time indicator 290. For example, a three hour rule may apply for the preparation of a chicken dish. The first time indicator 280 may provide an indication, such as, for example, a color change from white to green, after two and a half hours have expired since starting the timer. This would allow sufficient time to break down and refrigerate the remaining chicken, and still provide ample time for re-heating and serving within the three hour rule. The second time indicator 290 may provide an indication, such as, for example, a color change from white to red, after three hours have expired since starting the timer. This would indicate that the chicken should be pulled and discarded immediately. Fracturing the proximal portion 120 (FIG. 1) may stop the timers, providing a convenient record to either store in a log, or with the remaining food product, showing that the food product still has remaining serving-life.

Time indicators 280 and 290 may be started manually or automatically. For example, time indicators 280 and 290 may be started automatically after a trigger temperature is reached by a phase change from a solid to a liquid in a reservoir, with a wicking action used to vary the time from when the reservoir is liquefied until the indication is provided by time indicators 280 and 290. Separating the reservoir on the opposite side of the fracture line 140 from the time indicator 290 would provide for stopping the wicking action from indicating the time exceeded after fracture. By appropriately locating the distance between the reservoir and the indicating portion of the time indicators 280 and 290, and the position along the wick for the fracture line 140 relative to time indicators 280 and/or 290, any time limits useful for food service may be provided without undue experimentation.

A manual method of starting the time indicators 280 and 290 may be, for example, blocking an indicating fluid from the wick until starting the timer. The blockage may be removed by pulling a tab on the biotherm. The reservoir/wick timer described above is not intended to be a limiting description, but is provided as one example of timers known in the art useful in accordance with the present invention.

The temperature indicating dots 240, 250, 260 and 270 are examples of an array of temperature indicating dots that may be provided on the display 150. For example, the display 150 may include an array of 45 temperature indicating dots, including temperature indicating dots 240, 250, 260 and 270. The temperature indicating dots may be arranged in 9 rows and 5 columns of dots, as illustrated in Figure as a non-limiting example of possible arrangements. In the example illustrated in FIG. 2, each dot may provide an indication of 2 degrees Fahrenheit difference from the previous or next dot. In this example, each row would correspond to 10 degrees Fahrenheit, and the display would have a total range of 90 degrees Fahrenheit.

Continuing the chicken food product example above, it may be desirable to maintain the chicken at 161 degrees Fahrenheit during serving. Temperature indicating dot 250 may exhibit an observable change at 160 degrees Fahrenheit, indicated as having filled in the temperature indicating dot 250, shown as black in the illustration. Temperature indicating dot 260 is not filled in, indicating that the temperature has not reached 180 degrees Fahrenheit.

Temperatures, ranges, shapes, coloration descriptions, and labeling are provided as examples only, and are not intended to be limiting, but are examples intended to aid in the understanding of the present invention. For example, instead of indicating a heated state, it may be desirable to provide similar information for food products requiring refrigeration. For example, it may be desirable to maintain a cold food at or below 40 degrees Fahrenheit, such as in a refrigerator, on a buffet line, at a catered event, or the like. A biotherm in accordance with the present invention may be provided to non-reversibly indicate when a trigger temperature has been exceeded, and/or indicate a time limit has been exceeded above a trigger temperature.

The danger zone for serving heated foods is generally from about 40 degrees Fahrenheit to about 140 degrees Fahrenheit. Military standards require food to be thrown out after 3 hours between 40 and 140 degrees Fahrenheit. Embodiments of the present invention are useful as a danger zone indicator (DZI), also herein designated as “the Riley Factor.”

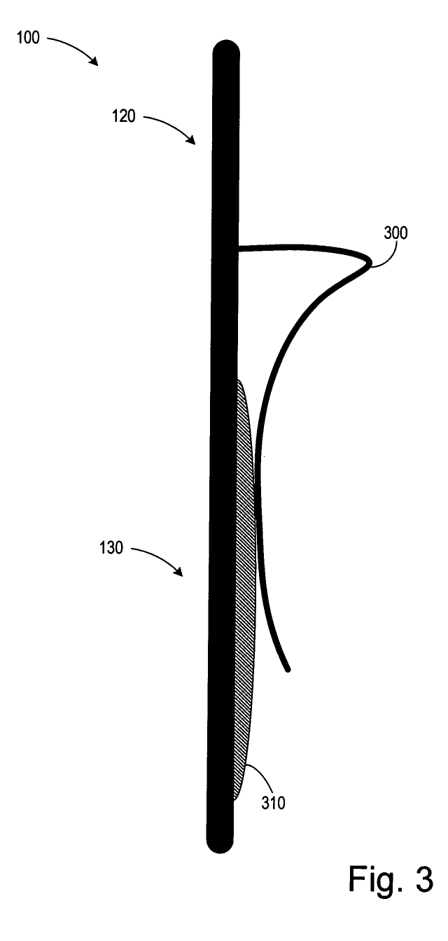

Referring now to FIG. 3, a side view of a biotherm 100 having a clip 300 is illustrated in accordance with an embodiment of the present invention. The clip 300 may be used to, for example, fasten the biotherm 100 to a pan and/or pot used for preparing and/or serving food. The clip 300 may be secured to the biotherm 100 at or near the fracture line 140 to improve fracturability and/or handling ease. If the fracture line 140 is provided on the distal portion 130, then breaking off the proximal portion 120 will remove the clip 300 from the proximal portion 120, simplifying retention of the proximal portion 120 for records keeping purposes.

The clip 300 may be manufactured from the same material as the body 110, or may be manufactured from any material suitable for securing the biotherm 100 to a pot or pan. For example, the clip 300 may be manufactured from a heavy foil, such as a thin aluminum sheet, that is malleable. The clip 300 may initially be flat against the body 110, and when desired, may be pulled out from the body 110, shaped around the edge of a pan, and then left to hold the body 110 in place for the useful life of the biotherm 100. In another embodiment, the clip 300 may be only somewhat malleable or non-malleable, and pre-formed to match the shape of standard cookware, such as, for example, standard serving pans for catered foodservices, hotels, restaurants, or the like. A non-malleable example of a clip 300 may be manufactured from spring steel.

The clip 300 may be used to initiate or trigger timers associated with the biotherm 100, such as the time indicators 280 and 290. For example, pulling the malleable clip 300 from the body 110 may remove the blockage from the reservoir described earlier, to trigger the time indicators 280 and 290. In another embodiment, the clip 300 may slide up and down the body 110 to provide for adjusting the depth of insertion of the biotherm 100 into different depth pans.

The ridges 310 and 320 are illustrated in FIG. 3 as extending back from the body 110, with a spring-like non-malleable version of the clip 300 pressing against the ridges 310 and 320. The ridges 310 and 320 are useful in this configuration to slightly separate the body 110 from the pan or pot, so that the reading of temperature from the biotherm 100 indicates food temperature, and not the metal pan temperature or heat source temperature.

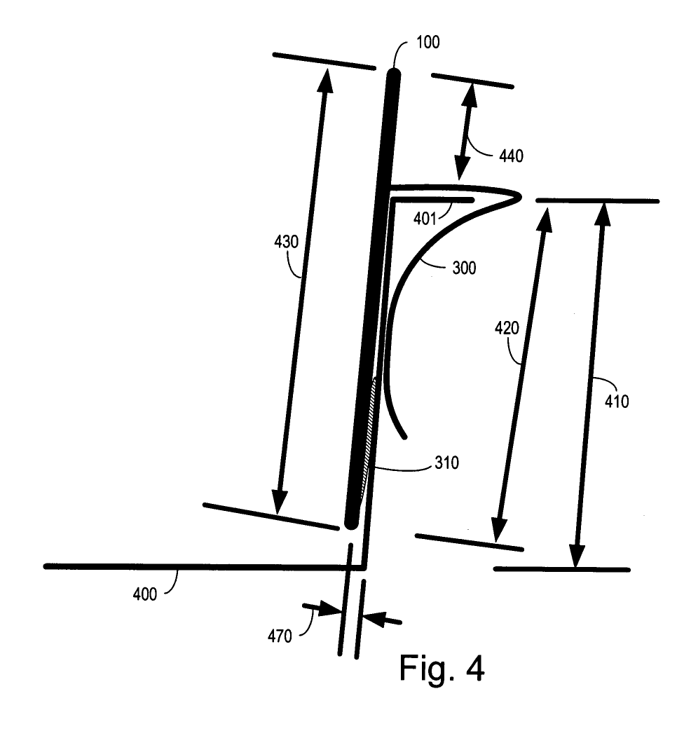

Turning now to FIG. 4, a biotherm 100 is illustrated inserted into a pan 400. Pan 400 is shown with a lip 401 around the top of the pan 400. The pan 400 has a depth 410 from the lip 401 to the bottom of the pan 400. Typical depths for the pan 400 for food service may be, for example, 2 inches, 4 inches, and 6 inches. The body 110 may have a height 430 configured to fit into specific size pans 400. For example, if the pan 400 is a 4 inch pan, the height 430 may be about 5 inches, so that the proximal portion 120 extends above the lip 401 for ease of viewing. The clip 300 may be located so that the clip 300 placed over the lip 401 provides some space between the bottom of the biotherm 100 and the bottom of the pan 400, such that the temperature reading is taken of the food in the pan 400, and not the heating or cooling elements below the pan 400. For example, the clip 300 may locate the body 110 at a depth 420 less than the full 4 inches of the pan depth 410. For example, the depth 420 may be only 75% of the depth 410.

It may also be beneficial to keep the body 110 from touching the pan 400 at the temperature sensing portions of the biotherm 100. The ridges 310 and 320 may extend behind the body 110 to provide a space 470 between the body 110 and the pan 400.

Each feature disclosed in this specification (including any accompanying claims, abstract, and drawings), may be replaced by alternative features having the same, equivalent or similar purpose, unless expressly stated otherwise. Thus, unless expressly stated otherwise, each feature disclosed is one example only of a generic series of equivalent or similar features.

While embodiments of the present invention have been shown and described herein, it will be obvious to those skilled in the art that such embodiments may be provided by way of example only. Numerous variations, changes, and substitutions will be apparent to those skilled in the art without departing from the invention. Accordingly, it is intended that the invention be limited only by the scope of the appended claims.

1. A single-use biotherm, comprising:
a biotherm body comprising a proximal end and a distal end;
a frangible portion, the frangible portion fracturably attached to the biotherm body;
a temperature sensitive arrangement located in or on the biotherm body; and
a first temperature indicating arrangement located in or on the frangible portion, the temperature indicating arrangement coupled to the temperature sensitive arrangement,
wherein fracturing the frangible portion from the biotherm body captures the temperature indicated by the temperature indicating arrangement.

2. The biotherm of claim 1, further comprising a second temperature indicating arrangement located in or on the frangible portion, the second temperature indicating arrangement coupled to the temperature sensitive arrangement, wherein the first temperature indicating arrangement is configured to indicate a first range of temperatures and the second temperature indicating arrangement is configured to indicate a second range of temperatures different than the first range of temperatures.

3. The biotherm of claim 1, further comprising a timer located in or on the biotherm body, the timer configured to indicate a time limit exceeded after a trigger event, the trigger event triggered by the temperature indicating arrangement.

4. The biotherm of claim 1, wherein the temperature sensitive arrangement is configured to be sensitive within the range of about 120 degrees Fahrenheit and about 180 degrees Fahrenheit.

5. The biotherm of claim 4, wherein the temperature sensitive arrangement is configured to be sensitive within the range of about 140 degrees Fahrenheit and about 170 degrees Fahrenheit.

6. The biotherm of claim 2 wherein the first temperature indicating arrangement is configured to indicate a temperature above about 140 degrees Fahrenheit and the second temperature indicating arrangement is configured to indicate a temperature of about 161 degrees Fahrenheit.

7. A single-use biotherm, comprising:
a biotherm body comprising a proximal end and a distal end;
a temperature sensitive arrangement located in or on the biotherm body; and
a first temperature indicating arrangement located in or on the biotherm body, the temperature indicating arrangement coupled to the temperature sensitive arrangement;
wherein the first temperature indicating arrangement is configured to indicate the temperature sensitive arrangement sensing a temperature exceeding a first set-point and is configured to indicate the temperature sensitive arrangement sensing a temperature below a second set-point after exceeding the first set-point.

8. The biotherm of claim 7, further comprising a second temperature indicating arrangement located in or on the biotherm body, the second temperature indicating arrangement coupled to the temperature sensitive arrangement, wherein the first temperature indicating arrangement is configured to indicate a first range of temperatures and the second temperature indicating arrangement is configured to indicate a second range of temperatures different than the first range of temperatures.

9. The biotherm of claim 7, further comprising a timer located in or on the biotherm body, the timer configured to indicate a time limit exceeded after a trigger event, the trigger event triggered by the first temperature indicating arrangement.

10. The biotherm of claim 7, wherein the temperature sensitive arrangement is configured to be sensitive within the range of about 120 degrees Fahrenheit and about 180 degrees Fahrenheit.

11. The biotherm of claim 10, wherein the temperature sensitive arrangement is configured to be sensitive within the range of about 140 degrees Fahrenheit and about 170 degrees Fahrenheit.

12. The biotherm of claim 8 wherein the first temperature indicating arrangement is configured to indicate a temperature above about 140 degrees Fahrenheit and the second temperature indicating arrangement is configured to indicate a temperature of about 161 degrees Fahrenheit.

13. A method of reducing cross-contamination, comprising:
providing at least one biotherm, the biotherm comprising:
a biotherm body comprising a proximal end and a distal end;
a temperature sensitive arrangement located in or on the biotherm body; and
a first temperature indicating arrangement located in or on the biotherm body, the temperature indicating arrangement coupled to the temperature sensitive arrangement;
inserting one of the single use biotherms into a food product;
receiving an indication of the temperature of the food product from the biotherm; and
disposing the biotherm after receiving the temperature indication from the food product or retaining at least a portion of the biotherm as a record of the indication of the temperature.

14. The method of claim 13, further comprising providing a plurality of biotherms, and inserting each of the plurality of biotherms into its own single food product, thereby eliminating cross-contamination between the food products.

15. The method of claim 13, wherein the at least one biotherm further comprises a clip configured to retain the biotherm in a pan of food.

16. The method of claim 13, wherein the temperature sensitive arrangement comprises a non-reversible temperature sensitivity.

17. The method of claim 13, wherein the temperature sensitive arrangement comprises a reversible temperature sensitivity.

18. The method of claim 13, comprising:
clipping the biotherm to a pan configured to contain a food product;
presenting the food product for consumption with the biotherm clipped to the pan;
receiving an indication of the food product from the biotherm; and
removing the pan containing any remaining portion of food product after receiving the indication from the biotherm.

19. The method of claim 18, wherein the indication is an indication of an improper temperature of the food product.

20. The method of claim 18, wherein the indication is an indication of a time limit exceeded for presentation of the food product.
